(19) United States
(12) Patent Application Publication
(10) Pub. No.: US 2008/0256560 A1
(43) Pub. Date: Oct. 16, 2008

(54) METHOD, SYSTEM AND COMPUTER PROGRAM FOR INTERACTING WITH SERVICES THROUGH A NATIVE USER INTERFACE IN A SOA ENVIRONMENT

(76) Inventors: Gaetano Ruggiero, Salerno (IT); Vincenzo Sciacca, Rome (IT); Massimo Villani, Roma (IT)

Correspondence Address: IBM CORPORATION;INTELLECTUAL PROPERTY LAW, 11501 BURNET ROAD, AUSTIN, TX, 78758, US

(21) Appl. No.: 11/766,956

(22) Filed: Jun. 22, 2007

(30) Foreign Application Priority Data
Jun. 23, 2006 (EP) 06115987.7

(51) Int. Cl. G06F 9/44

(52) U.S. Cl. 719/328

(57) ABSTRACT

A solution (200) for interacting with application services (240)—for example, in a SOA framework (215)—is proposed. For this purpose, a dedicated support service (245) is deployed on the same SOA framework. Any application service that is registered on the SOA framework requires the support service to deploy a corresponding user interface (250) of the native type. The application service listens on the user interface so deployed for any input; at the same time, the application service may output messages of its own motion through the same user interface in response to the reaching of specific internal states (such as an error condition).

### FIELD OF THE INVENTION

The present invention relates to the information technology field. More specifically, the invention relates to the interaction with services.

### BACKGROUND ART

Data processing architectures based on services (such as the “Service Oriented Architecture, or SOA”) have become increasingly popular in the last years. Generally speaking, a service consists of a stand-alone basic task; the service may be requested through a well-defined interface, which is independent of its underlying implementation. This promotes the reuse and the interconnection of the existing services (even among different platforms).

Particularly, the services can be combined into composite applications for whatever use. Each application so obtained is very efficient; indeed, the application may exploit different techniques, each one optimized for a specific situation. Moreover, this architecture strongly increases the flexibility of the resulting application. For example, it is possible to change the implementation of any service without any impact on the whole application; on the other hand, the application can be readily expanded with new functionalities as soon as the corresponding services are available.

All of the above strongly reduces the development costs of the applications. Particularly, this allows creating dynamic applications, which facilitate a quick response to changing market conditions in a cost effective way. Moreover, this drives an organization's focus towards activities and interactions, thereby acting as a unifying force between business and applications; as a result, it is possible to obtain applications that are optimized to support the actual business requirements.

The services are formally defined (for example, in a public document), so as to allow their invocation by any application. Moreover, some services may also expose a user interface for human beings; typically, the user interface consists of a Graphical User Interface (GUI) of the web type; in this way, the web GUI can be invoked through a standard program (browser) used to access the Internet. In other words, the browser may be considered a further service working like a sort of proxy, which consumes the (desired) service and exposes a front-end interface on behalf of it. A (human) user—requesting to interact with the service at issue—opens the browser to exploit the service through the corresponding web GUI, and then closes the browser when a corresponding transaction is terminated.

A drawback of this solution is that the interaction with the service only starts when the user opens the browser. Therefore, the proposed user interface is completely unsuitable to manage situations wherein the service must notify unsolicited information of its own motion (in response to specific internal states). For example, this may happen when a problem occurs in the service (so that the situation must be reported to a system administrator). Another example is when any user must be informed of the availability of the service as soon as it is activated. A still further example is the login to a common service that is used to grant access to (external) services that are secured by an account verification mechanism.

An additional problem arises when the services are used on simple devices—such as a Personal Digital Assistant (PDA) or a mobile telephone. Typically, these devices feature limited input units; for example, the PDA is provided with a touch-screen and the mobile telephone is provided with a small keypad. Therefore, the above-mentioned input units are not convenient for using a web GUI to interact with the service; indeed, the reduced options available make it quite awkward to open the browser and enter any required information and/or commands.

### SUMMARY OF THE INVENTION

In its general terms, the present invention is based on the idea of providing a further service dedicated to the management of the interaction with the services of interest.

Particularly, the present invention provides a solution as set out in the independent claims. Advantageous embodiments of the invention are described in the dependent claims.

More specifically, an aspect of the invention proposes a method for interacting with application services on a data processing system; the application services are implemented on a service framework. For each application service the method includes the following steps. At first, the application service is activated (such as registered). The application service then requests the instantiation of a user interface (for the application service) to a common support service, which is implemented on the same service framework. In response to the request, the support service instantiates the user interface. It is then possible to interact with the application service through the user interface.

Particularly, the user interface can be used to display messages in response to the reaching of specific internal states of the application service.

For example, the internal state consists of an error condition, a registration of the application service and/or its invocation.

In an embodiment of the invention, the support service exposes an abstract class for the user interface (which abstract class is implemented by the application service according to a desired layout of the user interface).

The proposed solution is particularly advantageous in a hand-held computer.

In a preferred embodiment of the invention, the user interface is of the native type.

For example, the solution according to an embodiment of the invention finds application in a SOA framework.

Another aspect of the invention proposes a computer program for performing the method.

A further aspect of the invention proposes a common support service for interacting with application services.

A still further aspect of the invention proposes a corresponding system.

### REFERENCE TO THE DRAWINGS

The invention itself, as well as further features and the advantages thereof, will be best understood with reference to the following detailed description, given purely by way of a non-restrictive indication, to be read in conjunction with the accompanying drawings, in which:

FIG. 1 is a pictorial representation of a data processing system in which the solution according to an embodiment of the invention is applicable;

FIG. 2 shows the functional blocks of the system;

FIG. 3 is an exemplary class diagram modeling an implementation of the solution according to an embodiment of the invention; and

FIG. 4 shows a diagram describing the flow of activities relating to an implementation of the solution according to an embodiment of the invention.

### DETAILED DESCRIPTION

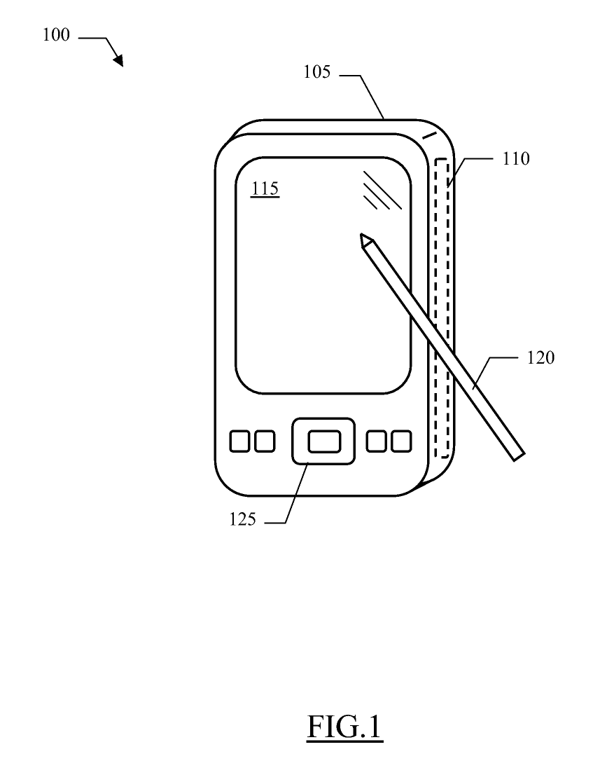

With reference in particular to FIG. 1, a data processing system 100 is illustrated; particularly, the system 100 is a PDA, also known as palmtop or pocket computer. The PDA 100 consists of a very small computer (which literally fits in one hand). The PDA 100 is very practical for simple personal functions, such as organizer, address book, calendar, calculator, media player, and the like; modern PDAs 100 can also access a wireless network, and then the Internet (for example, via the Wi-Fi technology), or they can be used as mobile telephones.

More specifically, the PDA 100 has a main body 105, which houses the electronic circuits 110 controlling its operations (such as a microprocessor, a working memory, a solid-state mass memory, drives for any input/output units, and the like). A user interacts with the PDA 100 via a touch-screen 115. A detachable electronic pen (or stylus) 120 is used to enter information on the touch-screen 115 (by tapping symbols/commands on a virtual keyboard, or by entering handwritten text for its automatic recognition). Typically, the PDA 100 is also provided with a few physical buttons 125 (for example, reserved for shortcuts to specific functions).

The PDA 100 is a typical device of the pervasive (or ubiquitous) computing type. Pervasive devices consist of components that are integrated in the environment (rather than being distinct objects), and that are commonly interconnected through wireless networks. The pervasive devices are very small (even invisible); moreover, they may be either mobile or embedded in any type of (smart) object. In any case, the pervasive devices always have very simple input units (for example, of the perceptive type).

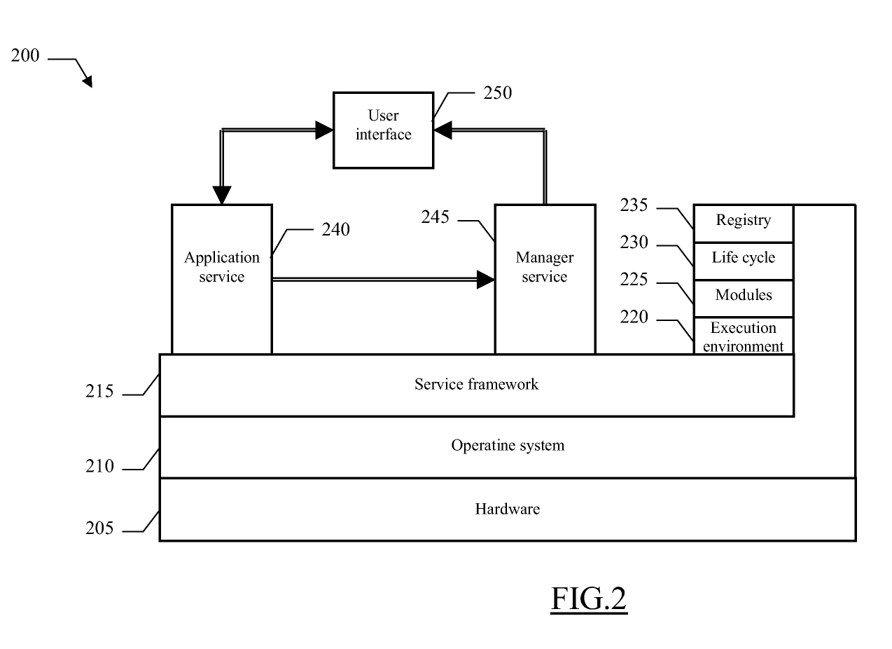

Moving to FIG. 2, the main (hardware and/or software) functional components of the PDA that may be used to implement the solution according to an embodiment of the present invention are denoted as a whole with the reference 200. The information (programs and data) is typically stored on the mass memory and loaded (at least partially) into the working memory of the PDA when the programs are running.

More specifically, the PDA is built on a hardware platform 205 (including the above-mentioned physical artifacts). An operating system 210 (for example, Linux) directly controls any resources of the hardware platform 205; the operating system 210 thus implements a software platform of the PDA, which provides all basic functions required for its operation. A service framework 215 runs on top of the operating system 210. The framework 215 defines a structure serving as a support for the development and organization of different services. Particularly, the framework 215 prescripts how the services should be built and how they should interact; generally, the framework 215 also provides actual programs (such as development tools, libraries, and the like), which may be used to build any standard functions of the desired services.

Preferably, the framework 215 conforms to the SOA specification. In the SOA context, each service consists of a repeatable task, which may be performed by any provider entity on behalf of any consumer entity. The SOA provides a description language for the formal specification of the function of each service (or contract) independently of its actual implementation; particularly, the contract includes the description of an interface of the service, which interface may be invoked by any consumer for performing the desired task. The SOA also specifies how the services inter-operate, so that they can work together to accomplish a more complex goal (with each service that may be either the provider of specific functions and the exploiter of other services). Particularly, the services are loosely coupled, meaning that each exploiter invoking a generic service makes its requirements explicit without any assumption about the corresponding provider; moreover, each interaction is self-contained (i.e., independent of each and every other interaction).

An available implementation of the SOA is the “IBM SOA Foundation” by IBM Corporation, which provides an integrated set of software, best practices and patterns (for example, including the “IBM WebSphere” and the “IBM Rational” applications again by IBM Corporation).

The SOA does not indicate any specific technology for its deployment. However, the SOA typically runs web services. Briefly, the web services are defined in a Web Services Description Language (WSDL) document, which is written in a XML-based specification conforming to the Universal Description, Discovery and Integration (UDDI) standard; particularly, for each available web service the WSDL document describes an abstract definition of messages that can be exchanged, and a concrete definition of their binding to specific transmission protocols. A typical example of transmission protocol that can be used to implement the web services is the Simple Object Access Protocol (SOAP); the SOAP is specifically designed for allowing communications among any kind of operating systems (and especially the transmission of remote procedure calls, or RPCs). The SOAP is in turn bound to an underlying transport protocol—such as the HTTP—which is used to actual convey the messages among different physical nodes (with each node that may support a different transport protocol).

In the pervasive environment at issue, the framework 215 is preferably conforming to the Open Services Gateway Initiative (OSGi) standard. The OSGi provides a service gateway, which consists of a set of Application Program Interfaces (APIs) in the Java language allowing communication and control between providers of services on the Internet and the pervasive devices. Particularly, those APIs can be used to remotely install, start, stop, update, and remove software applications (called bundles); each bundle consists of a set of packages (i.e., classes and resources) implementing a desired service.

Briefly, the (OSGi) framework 215 is divided in a number of layers. More specifically, an execution environment 220 (such as the Java Platform Standard Edition, or J2SE) specifies the minimum requirements for running the bundles. A further layer provides modules 225, which define class loading policies. A life cycle 230 implements the dynamic management of the bundles. At the end, a service registry 235 is used for the cooperation of the bundles. For this purpose, the registry 235 lists all the services that are instantiated on the framework 215, and then active on the PDA; for each active servicer the registry 235 describes its functions and the exposed methods that can be invoked. A commercial example of OSCi implementation is the “Service Management Framework (SMF)” by IBM Corporation.

A myriad of services implementing different applications (denoted with 240 in the figure) can run on the framework 215. Typically, these application services 240 consist of front-end components of services that have been discovered and then downloaded from the Internet (such as by means of a standard Jini service); for example, the application services 240 validate digital certificates, translate texts, signal events, supply information, and the like.

As described in detail in the following, in the solution according to an embodiment of the present invention a support service 245 manages a user interface 250 (preferably of the GUT type) for each application service 240. For this purpose, the application service 240 requires the manager service 245 to allocate the corresponding user interface 250 (at its activation). The application service 240 can then listen for any input on the user interface 250 (so as to react accordingly) and/or display messages of its own motion (in response to the reaching of specific internal states).

The proposed solution allows starting the interaction with the application service 240 by either the user or the application service 240 itself. In this way, it is possible to manage any situations wherein the application service 240 must notify unsolicited information; particularly, this may happen according to the life-cycle of the application service 240 and/or in response to asynchronous events—such as when a problem occurs, when the user must be informed of the availability of the application service 240 at its activation, or when an access must be granted to external services.

In addition, the same solution also allows implementing a native user interface (specifically implemented for the PDA). Particularly, it is possible to avoid using a web GUI (thereby preventing any difficulty caused by the interaction with a corresponding browser through the simplified input units of the PDA). All of the above strongly facilitates the usability of the application services 240 on the PDA.

It should be noted that the solution pointed out above is preferable to other possibilities that might be envisaged for implementing a native user interface of the application services 240 on the PDA.

For example, it would be possible to deploy a native application running on top of the operating system 210 directly (externally to the service framework 215). The native application then connects to the service framework 215, in order to exploit each desired application service 240; the native application can then expose the logic of the application service 240, by remaining in charge to display its user interface. However, this approach requires separate elements outside the service framework 215; as a result, a major engagement of the hardware resources of the PDA is required.

Another possibility would be of spawning a new thread for the user interface at the activation of each application service 240 (so as to avoid any engagement of the hardware resources of the PDA). However, this solution complicates the management of the user interface (since it is constrained to run in a single thread); this adversely affects the reliability of the user interface and its maintenance. Moreover, a specific user interface is required by each application service 240 (so that the corresponding code cannot be reused in any way).

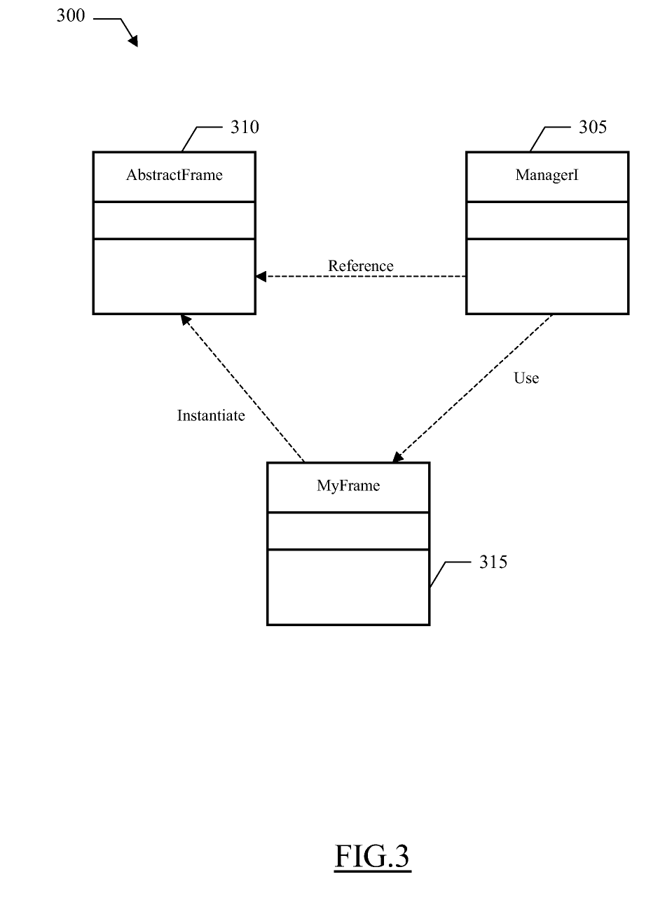

More in detail, as shown in FIG. 3, the manager service exposes a package 300. The package 300 includes an interface “ManagerI” 305 (consisting of a template definition basically containing the declaration of abstract methods, which are defined by any class implementing it). The interface 305 has a series of public methods that may be invoked from the outside; for example, a method “deploy( )” is used to instantiate a specific user interface, a method “show( )” is used to display the user interface, a method “forward( )” is used to switch to the user interface, a method “release( )” is used to destroy the user interface, and the like.

The interface 305 references an abstract class “AbstractFrame” 310 (which can only be inherited but not instantiated). The abstract class 310 has a series of public methods that may be used to manage different widgets; the widgets consist of controls that can be manipulated graphically to interact with the PDA (such as boxes, buttons, and the like). The widgets are typically grouped together, so as to define a toolkit that facilitates the development of the desired user interface; for example, the widget toolkit is based on the “Standard Widget Toolkit (SWT)” for Java of the “Eclipse Foundation”.

Each application service defines a concrete class “MyFrame” 315, which uses the interface 305 and instantiates the abstract class 310. The concrete class 315 defines the required abstract methods; particularly, a method “createShell( )” is used to specify the desired layout (with the corresponding widgets) of the user interface for the application service at issue.

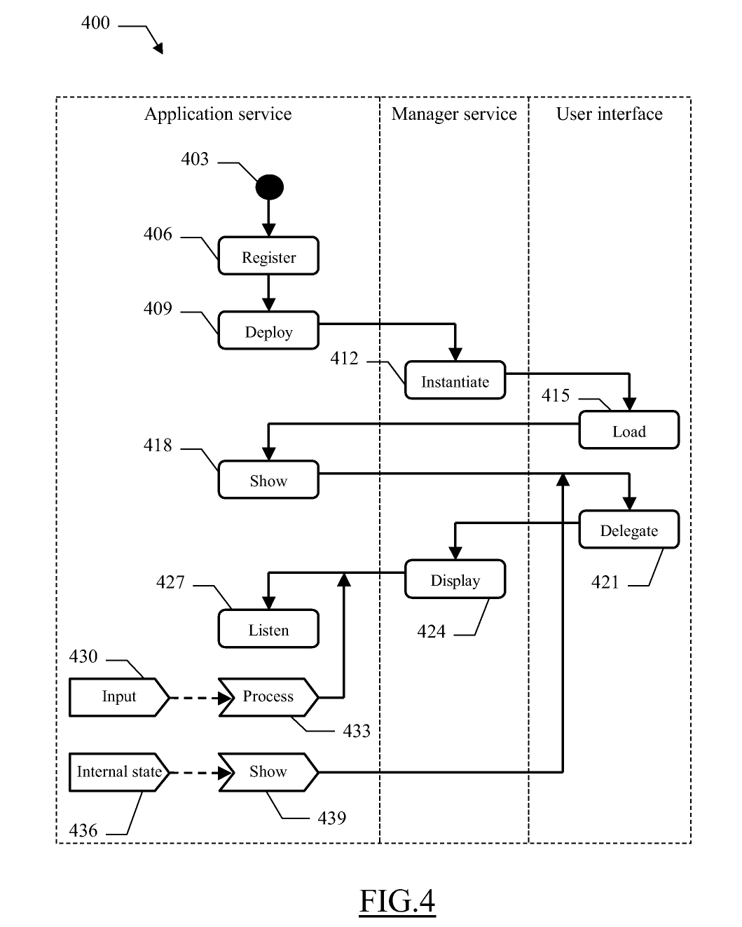

Considering now FIG. 4, the logic flow of an exemplary process that can be implemented in the above-described environment to interact with a generic application service is represented with a method 400.

The method begins at the black start circle 403 in the swim-lane of the application service. Descending into block 406, the application service is activated and then added to the registry. The process continues to block 409, wherein the application service requires the manager service to deploy a corresponding user interface (by calling the method “deploy( )” with the indication of the concrete class implementing the desired user interface). In response thereto, the manager service at block 412 instantiates this concrete class. As a result, the user interface of the application service is loaded at block 415 on an active display of the PDA (being initially hidden).

Returning to the swim-lane of the application service, if the application service needs to output any message immediately a corresponding request is submitted to the user interface just instantiated at block 418 (by calling the method “show( )”). Passing to block 421, the user interface delegates the operation to the manager service (so as to avoid any low-level software problems). In response thereto, the manager service at block 424 actually shows the user interface on the active display. This feature may be used to signal the availability of the application service to the user automatically at its activation (so as to allow the user to exploit the corresponding functionality).

The application service then implements a listening cycle at block 427 (in the same thread in charge of creating the user interface). As soon as the user enters any input, such as clicking on a command button (block 430), the application service processes the received information (performing any required action in response thereto). The flow of activity then returns to block 427 waiting for a new action by the user.

With reference now to block 436, the application service switches to a different internal state (either according to its life-cycle or in response to an asynchronous event). Assuming that the new internal state involves the outputting of a corresponding message for the user, the application service at block 439 submits a corresponding request to the user interface (by calling the method “show( )” again). The flow of activity then returns to the block 421 described above (so as to repeat the same operations of delegating the display of the desired information in the user interface to the manager service).

This feature may be used to implement an interaction with the user that is forced by the application service of its own motion. A typical example is that of an error that occurred in the application service; in this case, it is possible to display a message box with a description of the error and the indication of a possible action that should be necessary to recover operation of the application service. Another example is the requirement of an authentication of the user at the invocation of the application service (such as for granting an access to external services that are secured by an account verification mechanism); in this case, a login panel may be displayed (requiring the user to enter its name and password).

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

Particularly, similar considerations apply to different services requiring the deployment of a generic user interface at their activation (registration, invocation, and the like). However, any other interaction with the application service is possible (even without any human intervention).

It is emphasized that the above-described scenarios are not comprehensive. For example, the devised solution may find application only for receiving information and/or commands, only for outputting unsolicited information, or for any other purpose.

Moreover, the mentioned internal states of the application services (causing the display of corresponding messages) are merely illustrative; for example, an equivalent behavior is possible in response to inputs received from other application services, to a time-out (such as periodically), and the like.

Although in the preceding description reference has been made to a specific implementation of the manager service, it should be readily apparent that the same result may also be achieved with equivalent techniques. For example, the manager service may be realized with a similar package (having different and/or additional classes); in any case, it is possible to use a different widget toolkit, and a different language (even not of the object-oriented type).

Similar considerations apply if the PDA has another architecture or includes equivalent units (such as cache memories temporarily storing the programs or parts thereof to reduce the accesses to the mass memory during execution); in any case, it is possible to replace the PDA with a different hand-held computer (such as a mobile telephone, a GPS navigator, and the like), or more generally with any other pervasive device. However, the application of the proposed solution to a laptop computer, a desktop computer, a network of computers, or any equivalent code execution entity is within the scope of the invention.

Moreover, the same technique may be implemented with different user interfaces—such as of the speech synthesis or command line type; in any case, the use of a non-native user interface is not excluded in specific situations.

It should be readily apparent that the above-described implementation of the SOA framework (based on web services, and specially exploiting the OSGi technology) is merely illustrative. In any case, even though the invention has been described with great emphasis for the SOA framework, nothing prevents applying the same solution to whatever service-based architecture (for example, conforming to the CORBA standard).

Similar considerations apply if the program (which may be used to implement each embodiment of the invention) is structured in a different way, or if additional modules or functions are provided; likewise, the memory structures may be of other types, or may be replaced with equivalent entities (not necessarily consisting of physical storage media). Moreover, the proposed solution lends itself to be implemented with an equivalent method (by using similar steps, removing some steps being not essential, or adding further optional steps—even in a different order). In any case, the program may take any form suitable to be used by or in connection with any data processing system, such as external or resident software, firmware, or microcode (either in object code or in source code). Moreover, it is possible to provide the program on any computer-usable medium; the medium can be any element suitable to contain, store, communicate, propagate, or transfer the program. For example, the medium may be of the electronic, magnetic, optical, electromagnetic, infrared, or semiconductor type; examples of such medium are fixed disks (where the program can be pre-loaded), removable disks, tapes, cards, wires, fibers, wireless connections, networks, broadcast waves, and the like.

In any case, the solution according to the present invention lends itself to be implemented with a hardware structure (for example, integrated in a chip of semiconductor material), or with a combination of software and hardware.

1. A method for interacting with application services on a data processing system, the application services being implemented on a service framework, wherein for each application service the method includes the steps of:
activating the application service,
the application service requesting the instantiation of a user interface for the application service to a common support service, the support service being implemented on said service framework,
the support service instantiating the user interface in response to the request, and
interacting with the application service through the user interface.

2. The method according to claim 1, wherein the step of interacting includes, under the control of the application service:
reaching an internal state, and
causing the user interface to output a message corresponding to the internal state.

3. The method according to claim 2, wherein the internal state is an error condition, a registration, and/or an invocation of the application service.

4. The method according to claim 1, wherein the support service exposes an abstract class for the user interface, the application service implementing the abstract class according to a desired layout of the user interface.

5. The method according to claim 1, wherein the system is a hand-held computer.

6. The method according to claim 1, wherein the user interface is a native user interface of the system.

7. The method according to claim 1, wherein the service framework is a SOA framework.

8. (canceled)

9. A common support service for interacting with application services on a data processing system, the support service and the application services being implemented on a service framework, wherein the support service includes:
means for receiving a request from an activated application service for the instantiation of a user interface for the application service,
means for instantiating the user interface in response to the request, and
means for managing the interaction with the application service through the user interface.

10. The common support service as described in claim 9 further comprising:
a service framework, the application services being implemented on the service framework.

11. A computer program product including a computer-usable medium embodying a computer program, the computer program when executed on a data processing system causing the system to perform a method for interacting with application services on the system, the application services being implemented on a service framework, wherein for each application service the method includes the steps of:
activating the application service,
the application service requesting the instantiation of a user interface for the application service to a common support service, the support service being implemented on said service framework,
the support service instantiating the user interface in response to the request, and
interacting with the application service through the user interface.
